(19) United States
(12) Patent Application Publication
(10) Pub. No.: US 2010/0236119 A1
(43) Pub. Date: Sep. 23, 2010

(54) Beverage Identifier and Labeling System

(76) Inventor: Robyn Pellei, Charlotte, NC (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/728,447

(22) Filed: Mar. 22, 2010

Related U.S. Application Data
(60) Provisional application No. 61/162,281, filed on Mar. 21, 2009.

(51) Int. Cl. G09F 3/10; G09F 3/00

(52) U.S. Cl. 40/638; 40/299.01

(57) ABSTRACT

A beverage identifier is in the form of a ring or a flat strip attachable at each end to form a ring, and the ring fits around a beverage container. The beverage identifier includes a writing surface for temporarily affixing the name of the individual to whom the beverage container belongs. The writing surface is protected from beverage spillage by a surrounding wall. The beverage identifier further comprises an identifying character for users who do not read. A character name plate is adjacent the identifying character to assist a user in learning to read the name of the identifying character. A charm may be added to the beverage identifier for additional identification. The beverage identifier may include a system for counting the number of drinks completed with the associated beverage container.

### CROSS REFERENCE TO RELATED PATENT APPLICATIONS

This patent application claims priority to U.S. Provisional Patent Application 61/162,281 (Pellei) filed on Mar. 21, 2009. The provisional patent application is incorporated by reference as if fully set forth herein.

### FIELD OF THE INVENTION

The invention relates to a system and product for labeling beverage containers for adults and children. In particular, the invention relates to bands, or strips, that fit around a beverage container and provide a means for identifying that container for the consumer of that beverage. The bands may be of a single piece, closed, endless loop construction or may be in the form of a belt with a separate closure that holds the band in place.

### BACKGROUND OF THE INVENTION

Numerous products have been historically available for marking beverage containers, particularly for children's beverages. In a simple home system, the care giver can use a strip of masking tape and write on the tape to identify a cup, bottle or other container as belonging to a particular child. Other known systems include labels, either pre-printed or with a surface available for writing thereon.

One issue with masking tape or other labels is that they require an adhesive to stick to the container. Removing this adhesive becomes a messy job, and the beverage container becomes unsightly with bits of labels and previously used adhesives continuously stuck to the outside. To accommodate a simpler removal, one product, known as the Bumpy Name Orbit Bottle Label provides an elastomeric ring that can stretch around a child's sipping cup, bottle, or any beverage container. The Bumpy Name Orbit Bottle Label is pre-printed, or engraved, with a child's name and any special instructions for diet that are applicable to that child. Ordering pre-printed bands, however, proves expensive for parents with more than one child, as the band cannot be re-used or switched for use by a different child.

As shown in pending United States Patent Application Publication No. 2008/0023363 (Valadaz 2008), a beverage identification apparatus may be a stretchable ring of polymeric or elastomeric material that fits snugly about the circumference of a beverage container. The Valadaz apparatus includes a space for writing on the face of the ring. The writing space allows for writing a person's name to identify which beverage belongs to which person. The writing may be removable to allow re-using the same ring for a different person's beverage.

The Valadaz application is predominantly useful in marking adult beverages, or in marking beverages for children old enough to read their names. In further regard to the adult market, a beverage identifier known as Beer Bands™ is a closed ring of stretchable material that fits predominantly around a beer bottle. The Beer Bands™ include catch-phrases printed on the outside. The phrases (e.g., “bombed,” “sauced,” and the like) allow a consumer to identify their beverage in a way that is appropriate for a party or a mature audience. The Beer Bands™, however, provide no avenue for customization, and it is likely that more than one person in a room will have an identical band, which defeats the individuality that a consumer desires.

Other known ways of identifying a beverage among several in a room include an elastic band with a name tag affixed as a flap. See, United States Patent Application Publication Nos. 2005/0138854 (Simmons 2005) and 2006/0207132 (Vaughan 2006). These products are notable in that they include name tags on which the consumer may write their name, and they come in a variety of colors for additional identification. The name tags are looped about the band or attached to the band by a securing mechanism. The name tags, therefore, are separate and removable articles which make them inappropriate for small children who might accidentally ingest them.

In a different take on the traditional use of masking tape, U.S. Pat. No. 5,704,144 (Groth 1998) provides a pre-printed label that includes an adhesive at one end to attach the label around a beverage container and stick the ends of the label together. The Groth device, therefore, is similar to removable paper wrist bands that are often used as identification tags at special events. In this regard, they are not re-usable after tearing them off.

Even in light of the above devices, a need continues to exist in the art of beverage identification for cups and bottles used by adults and children of diverse ages. In particular, children who cannot read their names would benefit from clearly recognizable symbols, and adults who supervise children would benefit from being able to write on the identifying attachment.

### BRIEF SUMMARY OF THE INVENTION

A beverage identifier has a one piece body for removably securing around a beverage container and provides a writing surface within the one piece body. An identifying character is integrated into the one piece body and has at least one raised portion extending from a surface of the one piece body. The beverage identifier includes tactile features that are appealing to the user, such as a name plate that spells the name of the identifying character. In one embodiment, the beverage identifier is adapted to receive a charm or sliding bracket that also provides a surface for further identification.

### BRIEF DESCRIPTION OF THE DRAWINGS

FIG. 1 shows a front environmental view of a beverage identifying strip positioned on a cup according to this invention.

FIG. 2 shows a rear environmental view of a beverage identifying ring positioned on a cup according to this invention.

FIG. 3 shows an exploded view of the beverage identifying strip for positioning on a cup as in FIGS. 1 and 2.

FIG. 4 shows an environmental view of a beverage identifying strip for writing an identifying name directly onto the strip.

FIG. 5A shows a beverage identifier with a charm and peg as described herein.

FIG. 5B shows a side view of the charm and peg of FIG. 5A.

### DETAILED DESCRIPTION

The beverage identifier (10) of this invention labels a cup, sippy cup, bottle, or can for either children or adults. The purposes of the new beverage identifier (10) include, but are not limited to, (i) ending confusion about which drink container belongs to which individual; (ii) decreasing the spread of germs by individuals drinking from one another's cups; (iii) limiting the number of drinks thrown out due to individuals not being sure about who drank from the container previously; (iv) being reusable by washing (i.e., dishwasher safe) or by simply transferring the same beverage identifier to a different beverage container; (v) identifying the beverage of choice for a child or adult; (vi) identifying what type of beverage is in a container; and (vii) alerting individuals of allergies and medical conditions that might be associated with a consumer of a particular beverage.

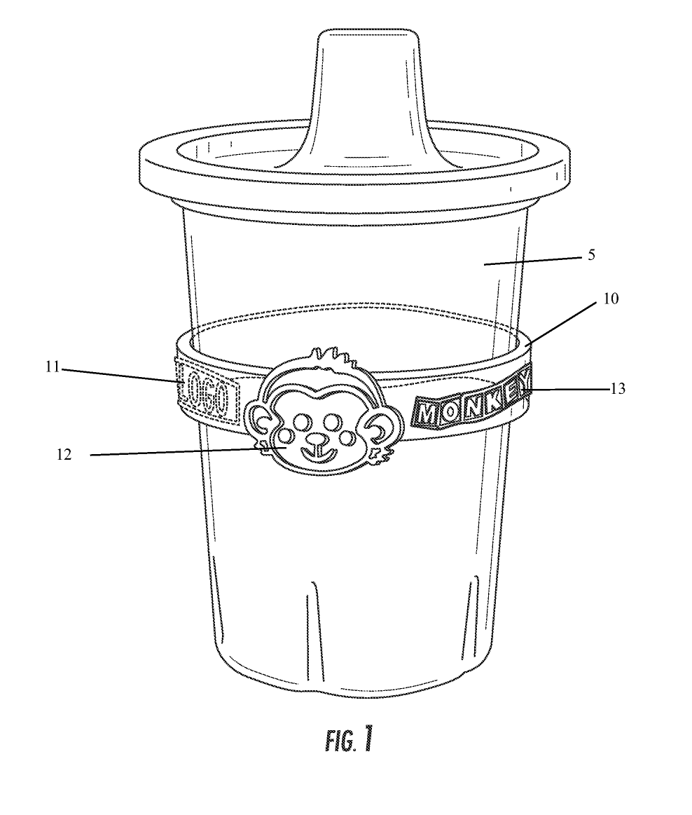

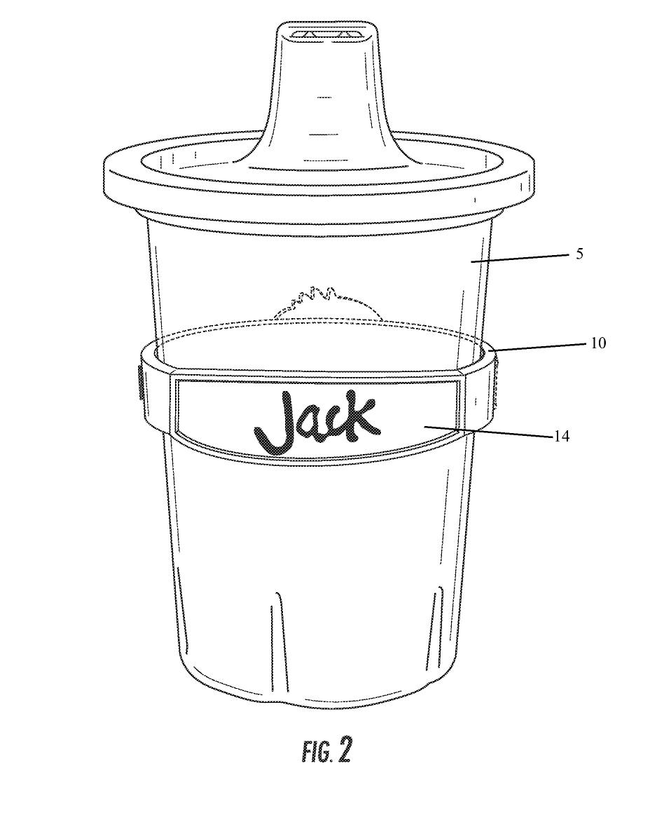

FIG. 1 shows a first embodiment of the beverage identifier (10) in the form of a stretchable ring made of elastomeric or polymeric materials. The ring is suitable to wrap around a beverage container (5) for identification purposes. In different embodiments, the beverage identifier may be a flat strip (not shown) with detachable ends that form a ring when attached by a clasp, button, clip, adhesive, fasteners, hook and loop, or any attachment mechanism. The beverage identifier, therefore, encompasses a one piece body, and in certain embodiments, the one piece body is a continuous, uninterrupted one piece body. The beverage identifier (10) is characterized in part by being identifiable in four ways. First, the colors are individualized for use by adults and children who can recognize the color of their beverage identifier and know which drink belongs to them. Second, the beverage identifier includes an identifying character (12). In FIG. 1, and by way of example only, the identifying character (12) is an animal. Of course the animal of FIG. 1 is not limiting of the invention, as the identifying character (12) may be in any shape that is recognizable by the user, including, but not limited to, human forms, other animals, and distinct shapes of every kind. Third, the beverage identifier (10) has the name (13) of the identifying character spelled out on the beverage identifier. Fourth, the beverage identifier (10) includes a prominent writing surface (14) with enough room to write a person's name and any instructions necessary to be associated with that beverage. The writing surface is shown in more detail in FIG. 2. The writing surface may be surrounded by a raised wall that protects the writing on the writing surface from spills that could smear the writing.

The figures show the beverage identifier (10) in the form of rings that stretch and fit around a beverage container. In use, the beverage identifiers (10) are sufficiently expandable to fit snugly around bottles, cans, cups, and the like of varying sizes. In this regard, the beverage identifiers may be formed of any stretchable material that allows for inclusion of the identifying character (12), character name plate (13), and the writing surface (14) for marking with semi-permanent or even temporary ink. A temporary ink is any ink or marking material that washes off after use so that the beverage identifier may be used again. In certain embodiments, the material may be an elastomeric polymer that retains its shape and allows for temporary deformation due to stretching. The ring (10) sufficiently maintains its original shape after each use to allow the ring to fit many different sizes of beverage containers in later uses.

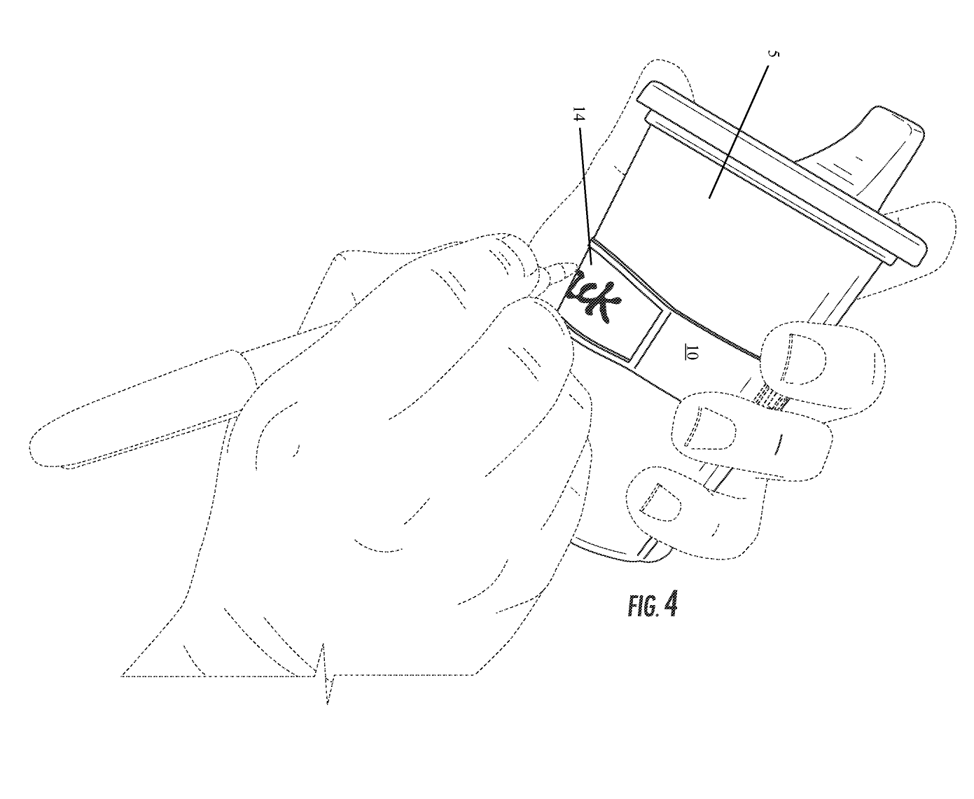

FIGS. 2 and 4 shows a clear use of an expanded writing surface (14) that allows the owner of a particular beverage (or a child's care giver) to write identifying information on the beverage identifier. The writing surface is also useful to write instructions and notes on the beverage identifier (10). For example, a parent can write “John A.—Soy Only” on the beverage identifier to make sure that a teacher or day care worker avoids giving John A. any kind of milk other than soy milk.

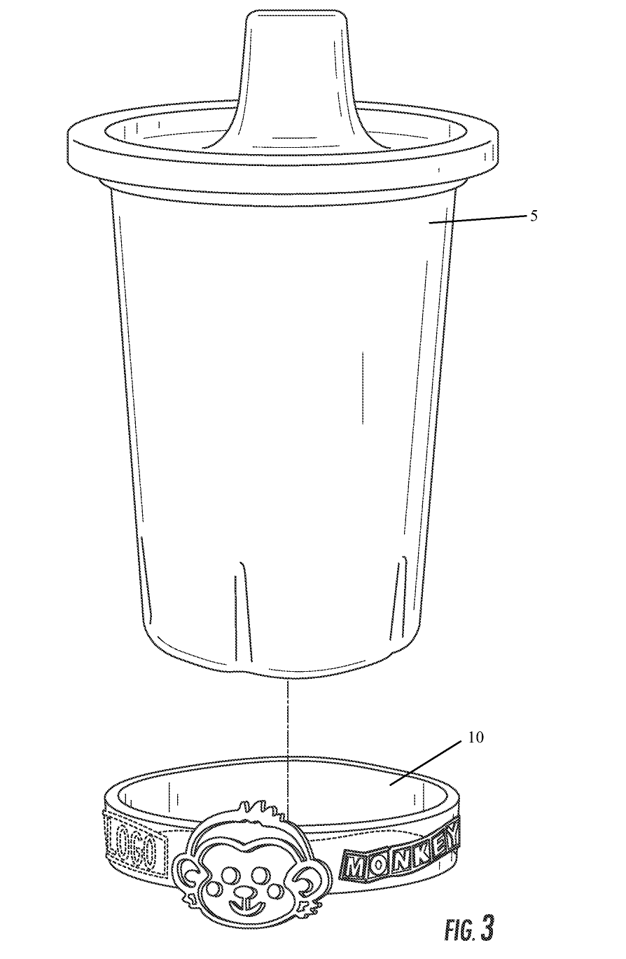

FIG. 3 shows an exploded view of a cup for a child (often referred to as a “sippy cup”) receiving a beverage identifier (10) according to this detailed description. FIG. 4 is an environmental view of a beverage identifier with a writing surface (14) and in use to identify a particular person's beverage.

The beverage identifier may be formed of a molded polymer such that the identifying characters (12) and the character names (13) on character name plates are part of the original mold. In this way the identifying character and its name are integral portions of the ring or strip itself, which allows for consistency in the product. The use of a mold also makes the beverage identifier safer because the identifying character (12) and character name plate (13) cannot dislodge to create choking hazards for children who use the product. In certain embodiments, at least one of the identifying character (12) and the identifying character name plate (13) have raised features (17) that emanate from the beverage identifier surface (15) to form ridges, indentations, and multi-level surfaces that one can feel as being at an elevation that is distinct from the surface of the beverage identifier. In FIGS. 1 and 3, the example of an identifying character (12) is in the shape of a monkey and has been manufactured to be an integral, non-removable part of the beverage identifier (10). The identifying character (12) includes features that one can distinguish by shape and orientation. For example, the eyes and cheeks of the identifying character are cylindrical, the face forms a base surrounded by ears and hair, both of which are shown as multi-level walls around the face. These characteristics give the identifying character a texture that is useful to (i) entice the user, particularly children, to touch the identifying character, (ii) make the identifying character distinct, appealing and easy to remember, and (iii) provide for identification tools for a user who is blind or sight impaired. The character name plate (13) of the identifying character (12) is also part of the uniform body of the beverage identifier in that it is not removable. Like the identifying character (12), the character name plate (13) is also multi-faceted and has at least one raised edge (19) that makes the lettering distinctive. In one embodiment, the character name plate (13) uses a print that is identifiable by children learning to spell. The identifying character (12) and the associated name plate (13) can be in the form of numerous items (e.g., toys, sports equipment, action figures, humans, animals, and shapes of all kinds).

The beverage identifier (10) of this invention includes features in addition to an individual's name or a writing space for a name. As shown best in FIG. 1, the beverage identifiers include specialized, distinctive features that aid in identifying a beverage for a child or even an adult. The identifying characters (12) are recognizable by children of very young ages and allow for identifying beverages without being able to read. The character name plate (13) is a learning tool as well as an identifier and is useful for children beginning to learn words like animal names. By making the character name part of the identification process, a child learning letters and words will readily pick out the right beverage identifier and most likely will take time to sound out the letters on the beverage identifier (10). By forming the identifying character (12) and any letters or symbols on the beverage identifier as part of a mold, these features take on an appealing tactile nature that children are likely to trace with their fingers. The beverage identifier, therefore, includes raised images, symbols, letters, numbers, or any molded figure that is noticeable to touch. Again, the goal is to keep track of which beverage belongs to any particular consumer. The more attractive and distinctive the beverage identifier, the more readily it will be recognized.

On a different portion of the ring or strip, the beverage identifier may also include an advertising area (11) for advertising or licensing proprietary company names, character brands, copyrighted materials, trademarks, and other marketing information to be associated with the beverage identifier. The information on the advertising area is non-removable in one embodiment. This concept provides an opportunity for advertising on the ring or strip, and the advertising can be associated with the identifying character. For example, if the identifying character (13) is Disney's Cinderella, then the advertising area (11) could be used for a Disney logo. Again, the advertising portion of the beverage identifier will most likely be recognizable by a small child with or without reading skills.

In any event, the identifying character may be associated with a theme. In the Figures, the theme is “jungle animals.” This is merely an example, as the theme may just as well be a flower garden, a bug display, cars, trucks, planets and stars, or any other group that is appealing to children.

The beverage identifier (10) further encompasses the strip or band fitting a charm (20) or a clasp about its body. The charm may be a flat one piece structure having clips or brackets (21) on one side to grip the beverage identifier (10) such that the charm can slide up and down the surface of the beverage identifier but remain attached to the beverage identifier. The charm may accommodate writing for identification information, similar to the writing surface (14) shown above. In yet another embodiment, the charm may be suitable for applying stickers that personalize the charm. In most embodiments, the charm is removable, or the charms may be added as in a traditional charm bracelet.

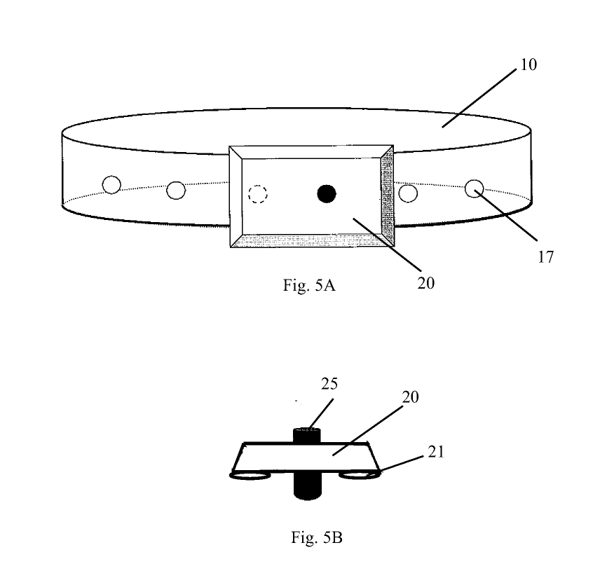

One charm of particular interest is shown in FIG. 5 and includes a peg (25) that securely fits within a hole (28) in the band or strip-type beverage identifier. A beverage identifier with a plurality of holes (17) allows the consumer, typically an older child or adult, to move the charm over to a different hole as a reminder or as a tracking system. For example, a person on a diet could use the charm to count the number of glasses of water drunk that day. By moving the charm to a different hole after each glass, the individual can monitor beverage consumption. This system could also be useful to adults consuming alcohol in order to ensure safe enjoyment of their beverages by limiting consumption to a certain number of “holes” on the beverage identifier. The beverage identifier (10) could include a numbering system (e.g., printed numbers next to each hole), for tracking the number of beverages consumed.

The charm embodiment, shown in FIG. 5, is useful to add an attachment to the beverage identifier. Such attachments could include a key chain, an ID card, or a personal item such as a small clock or a whistle. These items could be added to a hook or clip incorporated onto the charm. Furthermore, the attachment would be particularly useful for holding a locker key in a gym while the band is placed about a personal water bottle. In this way, the consumer keeps their beverage and their personal belongings in the same spot for safe retrieval.

The description of the beverage identifier is merely exemplary and numerous additions and other features are readily within the scope of this invention. The devices described herein meet all requirements of safety laws and are non-toxic for use by individuals of all ages.

1. A beverage identifier comprising:
a one piece body for removably securing around a beverage container;
a writing surface on said one piece body;
an identifying character integrated into said one piece body, said identifying character comprising at least one raised portion extending from a surface of said one piece body.

2. A beverage identifier according to claim 1, further comprising a character name plate integrated into said one piece body.

3. A beverage identifier according to claim 2, wherein said character name comprises at least one raised edge extending from said one piece body.

4. A beverage identifier according to claim 1, wherein said writing surface is erasable to remove writing thereon.

5. A beverage identifier according to claim 1, wherein said one piece body is in the shape of a closed ring.

6. A beverage identifier according to claim 1, wherein said one piece body is a flat strip attachable at each end to form a ring around a beverage container.

7. A beverage identifier according to claim 1, further comprising an advertising area.

8. A beverage identifier according to claim 7, wherein said advertising area comprises marketing information that is non-removable from the beverage identifier.

9. A beverage identifier according to claim 1, wherein said one piece body is adapted to receive a charm thereon.

10. A beverage identifier comprising:
a one piece body defining a plurality of holes for attaching a charm thereon;
a charm comprising a peg for engaging a hole in said one piece body.

11. A beverage identifier according to claim 10, wherein said charm is moveable to engage any one of the holes in said one piece body.

12. A beverage identifier according to claim 10, wherein said charm comprises at least one surface for receiving identification information.

13. A beverage identifier according to claim 12, wherein the identification information is removable writing.

14. A beverage identifier according to claim 12, wherein the identification information is a sticker.

15. A beverage identifier according to claim 12, wherein said one piece body further comprises a numbering system for associating each hole with a number for tracking a number of drinks consumed.

16. A beverage identifier according to claim 12, wherein said charm further comprises at least one bracket for securing the charm to said one piece body.

17. A beverage identifier comprising:
a one piece body for removably securing around a beverage container;
a writing surface on said one piece body;
an identifying character integrated into said one piece body, said identifying character comprising at least one raised portion extending from a surface of said one piece body;
a character name plate integrated into said one piece body.

18. A beverage identifier according to claim 17, wherein said character name plate is positioned adjacent said identifying character.

19. A beverage identifier according to claim 17, further comprising an advertising area adjacent said identifying character.

20. A beverage identifier according to claim 17, wherein said writing surface is surrounded by a raised wall to prevent spillage from a beverage container onto the writing surface.
